(19) United States
(12) Patent Application Publication
(10) Pub. No.: US 2005/0216358 A1
(43) Pub. Date: Sep. 29, 2005

(54) METHOD AND SYSTEM FOR EVALUATION SHOPPING

(76) Inventors: Julie A. Fichtner, Centerview, MO (US); Tiffany R. Stewart, Warrensburg, MO (US)

Correspondence Address: HOVEY WILLIAMS LLP, 2405 GRAND BLVD., SUITE 400, KANSAS CITY, MO, 64108, US

(21) Appl. No.: 10/908,312

(22) Filed: May 6, 2005

(51) Int. Cl. G06F 17/60

(52) U.S. Cl. 705/26

(57) ABSTRACT

A method and system for providing customer service evaluations to entities seeking testing of their employees' customer service skills. The method automatically records a mystery shopper's conversation with a targeted employee and attaches a corresponding voice file to a shopping report which can later be completed by the shopper. The mystery shopper first learns of a mystery shopping assignment and then calls a telephone recording system. The shopper is prompted to enter his or her user ID, a call code related to the shopping assignment, and the phone number of the target company. The telephone recording system then connects the shopper to the target company and automatically records the shopper's conversation with an employee of the company. Once the mystery shopper completes the assignment and hangs up, the recording is automatically converted to a voice file and transmitted to a web reporting system along with the call code. The web reporting system uses the call code to locate the shopping report corresponding to the assignment and then attaches the voice file to the shopping report. The mystery shopper may then access the web reporting system via the Internet or other communications network and complete the shopping report. The mystery shopper may also listen to the voice file while filling out the report to assist in its completion. Once the shopping report is completed by the mystery shopper and possibly edited by a supervisor of the mystery shopper, it is made available to the company that requested the evaluation.

### BACKGROUND OF THE INVENTION

1. Field of the Invention

The present invention relates to evaluation shopping. More particularly, the invention relates to an improved method and system for providing customer service evaluations to companies seeking testing of their employees' customer service skills.

2. Description of the Prior Art

Many companies often wish to evaluate their employees' customer service skills. One way to do so is with “mystery shoppers” who pose as customers in order to evaluate the friendliness, professionalism, knowledge, and/or other qualities of companies' receptionists, sales people and other customer service personnel. After evaluating a particular employee's customer service skills, a mystery shopper typically completes a shopping report which is made available to the company's management.

Those skilled in the art will appreciate that evaluating customer service skills is somewhat subjective. For example, an employee who seems to be abrupt to a mystery shopper may be merely considered efficient by the company, or vice-versa. Therefore, some mystery shopping services record conversations between their mystery shoppers and employees of evaluated companies so managers of the companies can determine for themselves the customer skills of their employees.

Unfortunately, prior art methods of recording mystery shopping calls require a great deal of manual manipulation and are therefore time-consuming and cumbersome. For example, one prior art method requires a mystery shopper to record his or her phone conversations with a digital voice recorder. At the conclusion of the phone call, the mystery shopper fills out a shopping report in which the employee's customer service skills are rated. The recording of the phone conversation is then uploaded to a computer, converted to a voice file, and attached to a digital copy of the shopping report as a .wav file or other suitable file format. The shopping report and attached voice file are then transferred to a central computer system where they can be accessed together by a manager of the company that was evaluated. Those skilled in the art will appreciate that these time-consuming and cumbersome steps greatly limit the number of recorded mystery shopping calls that can be made by a mystery shopper in a prescribed amount of time. These manual methods of recording a mystery shopping call also often result in the loss of the voice file and/or the shopping report.

Accordingly, there is a need for an improved evaluation shopping method and system that overcomes the limitations of the prior art.

### SUMMARY OF THE INVENTION

The present invention solves the above-described problems and provides a distinct advance in the art of evaluation shopping. More particularly, the present invention provides a method and system for at least partially automating the recording of customer service evaluations.

One embodiment of the invention is a method which automatically records a mystery shopper's conversation with a targeted employee and attaches a corresponding voice file to a shopping report which can later be completed by the shopper. The mystery shopper first learns of a mystery shopping assignment and then calls a telephone recording system. The shopper is prompted to enter his or her user ID, a call code related to the shopping assignment, and the phone number of the target company. The telephone recording system then connects the shopper to the target company and automatically records the shopper's conversation with an employee or other representative of the company.

Once the mystery shopper completes the assignment and hangs up, the recording is automatically converted to a voice file and transmitted to a web reporting system along with the call code. The web reporting system uses the call code to locate the shopping report corresponding to the assignment and then attaches the voice file to the shopping report. The mystery shopper may then access the web reporting system via the Internet or other communications network and complete the shopping report. The mystery shopper may also listen to the voice file while filling out the report to assist in its completion.

Once the shopping report is completed by the mystery shopper and possibly edited by a supervisor of the mystery shopper, it is made available to the company that requested the evaluation. A manager or other representative of the company may access the web reporting system via the Internet or other communications network and view the shopping report and listen to the attached voice file. The shopping report and/or the attached voice file may also be automatically e-mailed or otherwise sent to the manager or representative.

The present invention offers numerous advantages not realized by prior art evaluation shopping methods and systems. For example, the invention automates many of the steps of recording mystery shopping calls and therefore significantly reduces the complexity and time required to record mystery shopping calls. This allows mystery shoppers to complete a greater number of mystery shopping assignments in a given time period. The invention also virtually eliminates human errors associated with recording, saving, and transferring recorded mystery shopping calls.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a schematic diagram of exemplary computer and telephony equipment which may be used to implement certain aspects of a preferred embodiment of the present invention.

FIG. 2 is a flow chart showing the functionality and operation of certain aspects of a preferred embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

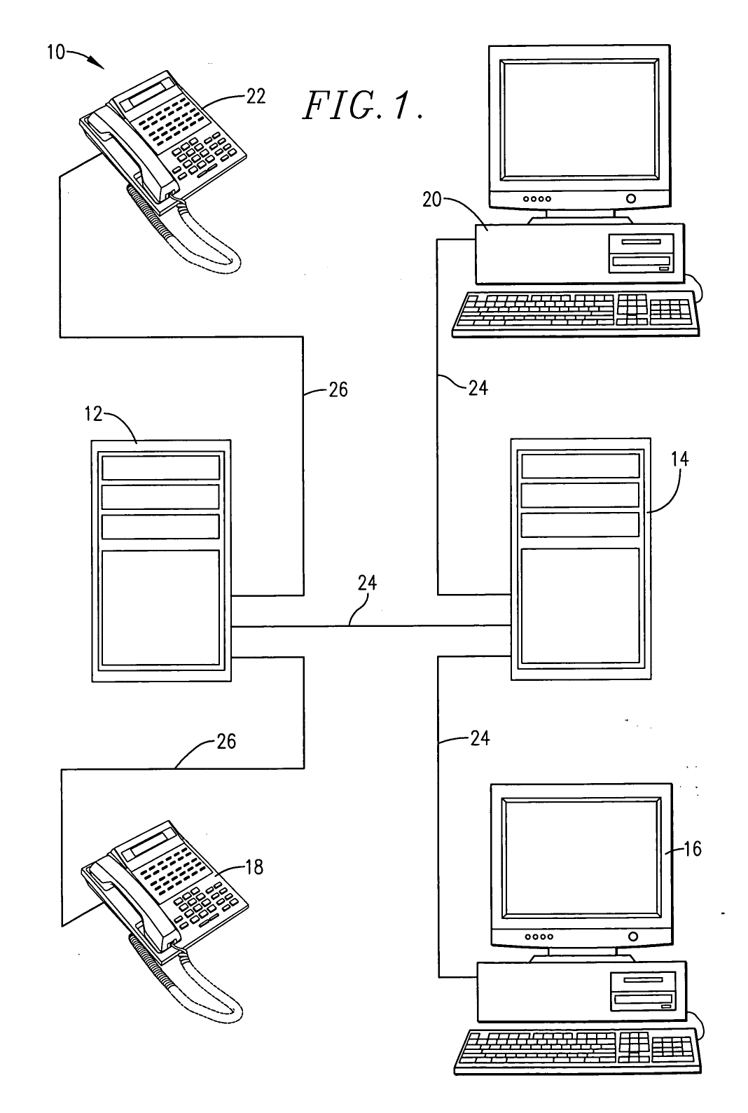

The present invention is preferably implemented with computer and telephony equipment broadly referred to by the numeral 10 in FIG. 1. The computer and telephony equipment 10 may include: a telephone recording system 12; a web reporting computer system 14; a computer 16 and a telephone 18 operated by a mystery shopper; and one or more computers 20 and one or more telephones 22 operated by a company or other entity which is to be evaluated by the mystery shopper.

The telephone recording system 12 is preferably an interactive voice response system such as the one operated by BYO Broadcast of Boston, Mass. The telephone recording system 12 allows for the automatic recording of telephone conversations and subsequent saving of the conversations as digital data files as described in more detail below. A telephone recording system which may be used with the present invention is described in U.S. Patent Application Publication No. U.S. 2001/0056351 A1, hereby incorporated into the present application by reference.

The web reporting computer system 14 preferably operates or hosts an Internet-accessible mystery shopping reporting system such as the Prophet System provided by Archon Development of Tallahassee, Fla. and serves as a repository for data and programs used to implement certain aspects of the present invention. The web reporting computer system 14 may include any computing device such as a network computer running Windows NT, Novel Netware, Unix, or any other network operating system. The web reporting computer system 14 may be connected to other computing devices that serve as fire walls to prevent tampering with information stored on or accessible by the web reporting computer system 14. The web reporting computer system 14 includes conventional web hosting operating software, an Internet connection such as a modem, DSL converter or ISDN converter, and is assigned a URL and corresponding domain name so that it can be accessed via the Internet in a conventional manner.

The telephone recording system 12 and the web reporting computer system 14 may be operated by the same entity or different entities. For example, both systems 12 and 14 may be operated by a company which provides mystery shopping services or may be operated by one or more entities which provide services to mystery shopping service companies. The telephone recording system 12 and web reporting computer system 14 may also be integrated into a single system.

The computer 16 and telephone 18 are operated by a mystery shopper that works for a mystery shopping service company such as ACE Mystery Shopping of Warrensburg, Mo. The mystery shopper may be an employee or manager of the mystery shopping company or may be an independent contractor that works for several different mystery shopping service companies. The mystery shopper may be required to attend training classes and be certified as an authorized mystery shopper.

The computer 20 and telephone 22 are operated by employees or other representatives of a company which wishes to have the customer service skills of its employees evaluated. The company, sometimes referred to herein as “customer” or “client”, may be an auto dealer, restaurant, retail store, casino, pharmacy, bank or any other entity that frequently deals with customers.

The computers 16 and 20 may be any types of devices that permit access to the web reporting computer system 14 via a communications network 24. For example, the computers 16 and 20 may be personal computers such as those manufactured and sold by Dell, Compaq, Gateway, or any other computer manufacturer, handheld personal assistants such as those manufactured and sold by Palm or Pilot, or even Internet appliances that are specifically designed for accessing the Internet. The computers 16 and 20 each preferably include or can access a conventional Internet connection such as a modem, DSL converter, or ISDN converter and a web browser that permits it to access the Internet. The communications network 24 is preferably the Internet but may be any other conventional communications network such as a local area network, a wide area network, a wireless network, or an intranet.

The telephones 18 and 22 are conventional and are coupled to the telephone recording system 12 via a communications network 26. The telephones 18 and 22 may also be internet-enabled devices capable of communications over a Voice Over Internet Protocol (VoIP) network. The communications network 26 may therefore be a plain old telephone system (POTs) network, the Internet, a local area network, a wide area network, a wireless phone network, or an intranet.

The computer and telephony equipment 10 illustrated and described herein are merely examples of equipment and networks that may be used to implement certain aspects of the present invention and may be replaced with other equipment without departing from the scope of the present invention.

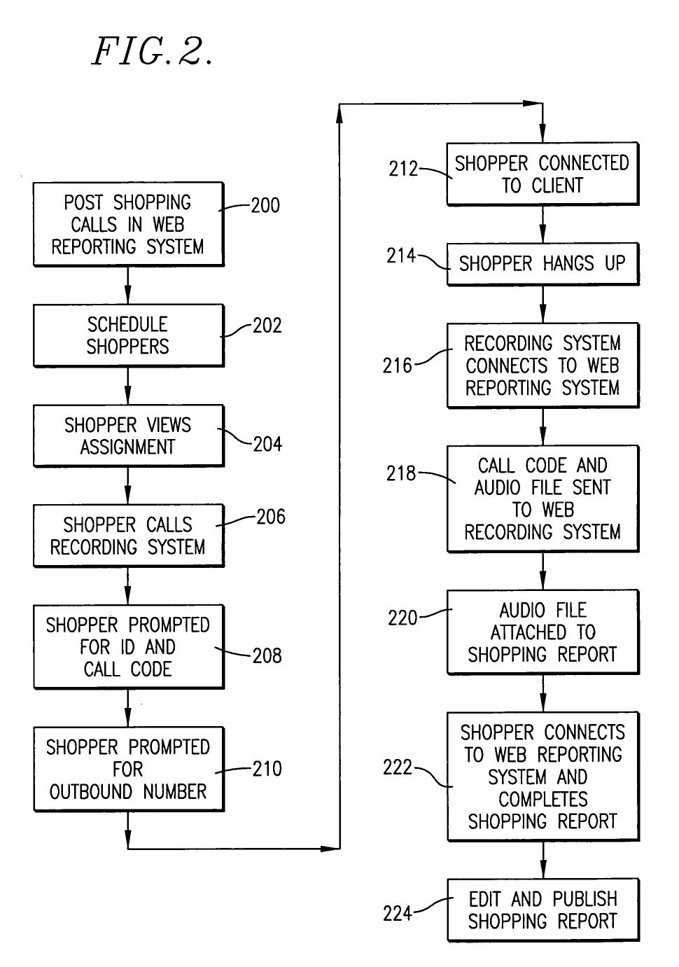

The flow chart of FIG. 2 shows the functionality and operation of a preferred implementation of the present invention in more detail. Some of the blocks of the flow chart may represent manual steps while others may represent a module segment or portion of code of a computer program which comprises one or more executable instructions for implementing the specified logical function or functions. The computer program can be stored on the telephone recording system 12, the web reporting computer system 14, or both and can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved.

Referring now to FIG. 2, a mystery shopping services company such as ACE Mystery Shopping first receives a request for a specified number of mystery shopping calls from a customer such as an auto dealership. Each of the requested mystery shopping calls is posted in the web reporting computer system 14 as depicted by box 200 so that it can be accessed by a mystery shopper such as a shopper operating the computer 16 and the telephone 18. Each posting includes details of the mystery shopping assignment such as the identity and phone number of the company to be called, the purpose of the call, the target person or persons at the company, and questions to be asked as a part of the mystery shopping evaluation. Preferably, some or all of these details are in a mystery shopping report added to each posting. Parts of the shopping report are preferably pre-populated with data by the mystery shopping service company and/or the web reporting computer system 14 and parts are to be completed by the mystery shopper after a mystery shopping assignment has been completed.

After at least one mystery shopping call has been posted to the web reporting computer system 14, shoppers are scheduled for the assignments as depicted in box 202 of FIG. 2. Mystery shoppers may be scheduled in a number of ways. One is to automatically send out emails or other notices to pre-qualified shoppers informing them of the new shopping call assignments. The shoppers may then log into the web reporting system 14 and accept an assignment. Another way is to personally invite particular mystery shoppers to accept an assignment via email, a phone call, etc. Once the mystery shoppers have been scheduled, they may log into the web reporting system 14 and view the specific details of the assignments as depicted in box 204.

To begin a mystery shopping assignment, a mystery shopper first uses the phone 18 to call the telephone recording system 12 (preferably a toll free number) as depicted in box 206 and is prompted to enter an assigned PIN number or other ID and a call code that was provided with the particular shopping assignment. The PIN number or other ID verifies that the mystery shopper is authorized to perform the assignment and the call code identifies the particular shopping assignment and corresponding shopping report.

If the mystery shopper enters a valid ID and call code in box 208, the telephone recording system 12 prompts for the telephone number of the company to be evaluated as depicted in box 210. The telephone recording system 12 may also access the web reporting system 14 and automatically retrieve the phone number from the shopping report associated with the entered call code. The shopper is then connected to the telephone 22 of the customer via the telephone system 12 as depicted in box 212.

As soon as the mystery shopper is connected to the telephone 22 of the customer, the telephone recording system 12 begins to record the phone conversation. Alternatively, the mystery shopper may indicate when recording should begin by pressing an assigned number on his or her telephone 18. At this point, the mystery shopper performs an evaluation of the customer service skills of an employee of the customer in a conventional manner. For example, the mystery shopper may ask specific questions, request information, etc. and evaluate the customer service skills of the employee. At the conclusion of the customer service evaluation, the mystery shopper may inform the employee that the call was part of a mystery shopping service or may remain anonymous.

As soon as the mystery shopper hangs up the telephone 18 as depicted in box 214, the phone recording system 12 communicates with the web reporting system 14 via the communications network 24 as depicted in box 216. Specifically, the phone system transfers the call code for the completed assignment to the web reporting system 14 so that the web reporting system can access the associated shopping report. The phone recording system 12 then transfers a voice file of the phone recording to the web reporting system 14 as depicted in box 218. The voice file is then attached to the corresponding shopping report as depicted in box 220. The voice file may be a .wav file and may be created by the phone recording system 12 or the web reporting system 14.

If the mystery shopper wishes to abort a recording during an assignment, he or she may press an assigned number or code such as 7. Upon detecting this number or code, the telephone recording system 12 either stops and erases the recording or sends it to a trash bin in the web reporting system 14. This allows the mystery shopper to re-do a shopping assignment if the wrong person answers the telephone 22 or if the evaluation is otherwise undesirable.

Any time after hanging up, the mystery shopper may access the web reporting system 14 via the computer 16 to complete the shopping report as depicted in box 222. To do so, the mystery shopper accesses the web reporting system 14 via the communications network 24, enters his or her PIN number and the call code for the mystery shopping assignment. The partially completed shopping report is then displayed so that the mystery shopper can complete it by answering certain questions, providing comments, etc. The shopper may also listen to the attached voice file while completing the shopping report.

Once the mystery shopper accesses the web reporting system 14 and enters the call code, the web reporting system 14 and phone recording system will not allow the mystery shopper or any other shoppers to record another phone conversation with the same call code. However, as long as the mystery shopper doesn't first access the web reporting system 14 and enter the call code, he or she may use the same call code more than once and record more than one phone conversation. In this case, the web reporting system 14 will recognize the last recording as the “good” one and will delete or otherwise discard any previous recordings. Alternatively, the web reporting system 14 can be programmed to keep all recordings so that several voice files can be attached to a single shopping report.

After a shopping report has been completed by a mystery shopper, it may be edited by managers of the mystery shopping company as depicted in box 224. Managers or other authorized personnel may also re-do a mystery shopping assignment and replace a prior voice file with a new voice file even after a mystery shopper has completed a shopping report by entering an appropriate authorization code.

Once a shopping report has been completed and edited, it is then made available to the customer who requested the assignment. The mystery shopping report and voice file may be automatically emailed to the customer's computer 20 or a notification that a shopping report is available on the web reporting system 14 may be sent to the customer. In either event, a representative of the customer may simultaneously access both the shopping report (preferably a PDF version) and the attached voice file.

Although the invention has been described with reference to the preferred embodiment illustrated in the attached drawing figures, it is noted that equivalents may be employed and substitutions made herein without departing from the scope of the invention as recited in the claims. For example, the particular computer, telephony, and communication network equipment and systems described herein may be replaced with other equipment and systems. Similarly, the equipment and systems may be operated with various different entities or a single entity without departing from the scope of the claims.

Having thus described the preferred embodiment of the invention, what is claimed as new and desired to be protected by Letters Patent includes the following:

1. A method of providing customer service evaluations comprising the steps:
receiving a telephone call from a shopper;
prompting the shopper to enter or verify a call code associated with a shopping report for an entity to be evaluated;
connecting the shopper to the entity so the shopper can communicate with a representative of the entity;
recording the shopper's communication with the representative and creating a corresponding audio file;
attaching the audio file to the shopping report once the shopper has completed the communication;
permitting the shopper to complete the shopping report based on the shopper's communication with the representative; and
permitting the entity to access the completed shopping report and attached audio file.

2. The method of claim 1, wherein the audio file is automatically attached to the shopping report when the shopper or the representative hangs up.

3. The method of claim 1, further including the step of storing an uncompleted version of the shopping report and the call code in a web reporting system prior to receiving the call from the shopper.

4. The method of claim 3, wherein the audio file is attached to the shopping report only if the call code entered or verified by the shopper matches the call code stored with the shopping report.

5. The method of claim 1, further including the steps of prompting the shopper to enter or verify a caller ID and comparing the caller ID to a list of known ID's to verify that the shopper is authorized to perform the customer service evaluation.

6. The method of claim 3, wherein the shopper completes the shopping report by accessing the web reporting system, entering or verifying the call code, and answering questions presented by the shopping report.

7. The method of claim 1, further including the step of e-mailing the completed shopping report to the entity.

8. The method of claim 1, wherein the call from the shopper is received by an interactive voice recording system.

9. The method of claim 8, wherein the shopping report is stored in a web reporting system.

10. The method of claim 9, wherein the interactive voice recording system and the web reporting system are both operated by the same entity.

11. The method of claim 9, wherein the interactive voice recording system and the web reporting system are operated by different entities.

12. A method of providing a customer service evaluation of an entity comprising the steps:
recording a shopper's conversation with a representative of the entity;
automatically attaching an audio file of the recording to a shopping report once the shopper has completed the conversation; and
permitting the shopper to access and complete the shopping report.

13. The method of claim 12, wherein the audio file is automatically attached to the shopping report once the shopper or the representative of the entity hangs up.

14. The method of claim 13, further including the step of permitting a representative of the entity to access the completed shopping report and the attached audio file.

15. The method of claim 12, further including the step of e-mailing the completed shopping report to the entity.

16. The method of claim 12, wherein the shopping report is stored in a web reporting system.

17. A method of providing a customer service evaluation of an entity comprising the steps:
posting a shopping call assignment in a web reporting system;
storing an uncompleted shopping report related to the shopping call assignment in the web reporting system;
permitting a shopper to access the web reporting system and the shopping call assignment to obtain instructions relating to the customer service evaluation;
prompting the shopper to call a voice recording system;
connecting the shopper to a representative of the entity with the voice recording system;
recording the shopper's conversation with the representative;
attaching a voice file of the shopper's conversation with the representative to the shopping report;
prompting the shopper to access the web reporting system and complete the shopping report; and
permitting a representative of the entity to access the completed shopping report and attached voice file.

18. The method of claim 17, wherein the audio file is automatically attached to the shopping report when the shopper or the representative hangs up.

19. The method of claim 17, further including the step of e-mailing the completed shopping report to the entity.

20. The method of claim 17, wherein the interactive voice recording system and the web reporting system are both operated by the same entity.

21. The method of claim 17, wherein the interactive voice recording system and the web reporting system are operated by different entities.

22. An evaluation shopping system comprising:
a telephone recording device operable to—
receive a call from a mystery shopper,
prompt the shopper to enter or verify a call code,
connect the shopper to a telephone operated by an entity associated with the call code,
record a conversation between the shopper and a representative of the entity, and
transmit the call code and a voice file representative of the recorded conversation when the shopper hangs up; and
a web reporting system operable to—
receive the call code and the voice file from the telephone recording system,
retrieve a shopping report associated with the call code, and
attach the voice file to the shopping report.
